(19) United States
(12) Patent Application Publication
(10) Pub. No.: US 2018/0229636 A1
(43) Pub. Date: Aug. 16, 2018

(54) SEAT APPARATUS FOR VEHICLE

(71) Applicant: HONDA MOTOR CO., LTD., Tokyo (JP)

(72) Inventors: Muneatsu Minato, Utsunomiya-shi (JP); Hajime Ishihara, Utsunomiya-shi (JP); Manabu Matsumoto, Utsunomiya-shi (JP); Yosuke Nishimura, Sakura-shi (JP)

(21) Appl. No.: 15/886,865

(22) Filed: Feb. 2, 2018

(30) Foreign Application Priority Data
Feb. 10, 2017 (JP) 2017-023078

(51) Int. Cl. B60N 2/70; B60N 2/68; B60N 2/72; A47C 7/28

(52) U.S. Cl. CPC B60N 2/7011; A47C 7/282; B60N 2/72; B60N 2/68

(57) ABSTRACT

A seat apparatus for a vehicle includes a seatback that supports a back of a person sitting on the seat apparatus and that includes a first support body and a second support body, the first support body being one side of the seatback in a seatback width direction and the second support body being the other side of the seatback in the seatback width direction, one of the first support body and the second support body being a movable support body, and a moving mechanism that displaces the movable support body from a back support position, where the movable support body is placed in order to support the back of the person sitting on the seat, to a retracted position where the movable support body is placed in order to create an open space where the movable support body was placed.

### CROSS-REFERENCE TO RELATED APPLICATION

Priority is claimed on Japanese Patent Application No. 2017-023078, filed Feb. 10, 2017, the content of which is incorporated herein by reference.

### BACKGROUND

### Field of the Invention

The present invention relates to a seat apparatus for a vehicle.

### Description of Related Art

In recent times, research on automatic driving of vehicles has been in progress. In technology related to automatic driving, there is a technology for performing automatic driving for drive assistance in certain road sections. In this regard, there is also a technology related to automatic driving of switching between a manual driving mode, in which a driver's driving operation is needed, and an automatic driving mode. During automatic driving, a situation where an occupant including a driver may change a seating position in a passenger compartment. When the seating position of the occupant is changed, for example, pushing down the seatback and allowing an occupant to come and go in a vehicle forward/rearward direction may be conceived. In this case, since the occupant appears to be coming and going over the seatback, the occupant may feel a psychological resistance.

Meanwhile, a configuration in which a pivot shaft extending in an upward/downward direction is provided at one end portion of a seatback in a seat width direction, the seatback is pivotable about the pivot shaft, and the seatback can be opened and closed like a door is known (for example, see Japanese Unexamined Patent Application, First Publication No. 2005-52405). In this case, it can be considered that changing of the seating position of the occupant can be smartly (easily) performed without the necessity of the occupant for going and coming over the seatback.

### SUMMARY

However, in the configuration of the related art, since the entire seatback is pivoted about the one end portion in the seat width direction, an occupant needs to largely avoid the seatback that is pivoting. In particular, in Japanese Unexamined Patent Application, First Publication No. 2005-52405, since the seatback is pivoted so as to move forward, it is difficult to perform the pivoting movement of the seatback when there is a person sitting on a seat. In addition, since the pivot shaft of the seatback is provided at an inner end portion in the vehicle width direction and the seatback pivots while having an outer end of the seatback in the vehicle width direction as a free end, it does not fit well with a walk-through configuration in which an occupant passes through the passenger compartment in the vehicle width direction.

An aspect of the present invention is to provide a seat apparatus for a vehicle in which an occupant moving space is able to be secured by moving a seatback, while an influence on a sitting space is minimized.

A seat apparatus for a vehicle according to the present invention employs the following configuration.

(1) A seat apparatus for a vehicle according to the present invention includes a seatback that supports a back of a person sitting on the seat apparatus and includes a first support body and a second support body, the first support body being one side of the seatback in a seatback width direction and the second support body being the other side of the seatback in the seatback width direction, one of the first support body and second support body being a movable support body; and a moving mechanism that displaces the movable support body from a back support position to a retracted position, the back support position being a position where the movable support body is placed in order to support the back of the person sitting on the seat, the retracted position being a position where the movable support body is placed in order to create an open space where the movable support body was placed.

According to the configuration of above mentioned (1), a configuration in which the seatback is provided as a left-and-right split structure, one of the first support body and the second support body that are separate left and right bodies of the seatback is provided as a movable support body, the movable support body is moved from the back support position at which the back of a person sitting on the seat is supported to the retracted position, and a position at which the movable support body was disposed is made to an open space. Accordingly, an occupant can come and go through the open space created by the seatback, and changing the seating position of the occupant becomes easier. That is, since one of the separate left and right bodies of the seatback is moved to create the open space, compared to a case in which the entire seatback is moved to create an open space, an occupant moving space can be secured by moving the seatback while an influence on the sitting space can be minimized.

(2) In the aspect of above mentioned (1), the movable support body may form an inner side of the seatback in the seatback width direction.

According to the configuration of above mentioned (2), since the movable support body that forms the inner side of the seatback in the seatback width direction is moved to create the open space, the occupant moving space can be secured at the inner side of the passenger compartment in the vehicle width direction, and this configuration can fit well with a walk-through configuration in which the inner side of the passenger compartment in the vehicle width direction is made as a pathway for the occupant.

(3) In the aspect of above mentioned (1) or (2), the moving mechanism may include a pivot shaft vertically extending at an inner side of the seatback in the seatback width direction, and the moving mechanism may displace the movable support body from the back support position to the retracted position by pivoting the movable support body about the pivot shaft.

According to the configuration of above mentioned (3), since the movable support body is pivoted about the pivot shaft provided at an inner side in the seat width direction in order to create the open space at the outer side in the seat width direction (inner side of the seatback in the vehicle width direction), the occupant moving space can be easily secured at the inner side of the passenger compartment in the vehicle width direction.

(4) In the aspect of any one of above mentioned (1) to (3), the moving mechanism may displace the movable support body from the back support position to the retracted position by moving the movable support body rearward.

According to the configuration of above mentioned (4), since the movable support body is displaced from the back support position to the retracted position by moving rearward, the open space can be easily created even when a person is sitting on the seat, and the occupant moving space can be easily secured.

(5) In the aspect of any one of above mentioned (1) to (4), the other one of the first support body and the second support body may be set as a fixed support body, and the fixed support body may form an outer side of the seatback in the seatback width direction and at least a portion of a seat belt apparatus may be held at the fixed support body.

According to the configuration of above mentioned (5), as the portion of the seat belt apparatus is held at the fixed support body that forms the outer side of the seatback in the vehicle width direction, the seat apparatus including the seat belt apparatus can be efficiently formed.

(6) In the aspect of any one of above mentioned (1) to (5), the seat apparatus may further include a support body locking mechanism that fixes the movable support body at the back support position; and a seat controller that controls the support body locking mechanism, wherein the seat controller may fix the movable support body at the back support position by using the support body locking mechanism when a vehicle on which the seat apparatus is mounted operates in a first driving mode in which a level of automatic driving is less than a predetermined reference, and may enable a fixing releasing operation of the support body locking mechanism when the vehicle operates in a second driving mode in which the level of the automatic driving is the predetermined level or more.

According to the configuration of above mentioned (6), in the first driving mode in which the degree of automatic driving is less than the predetermined level such as during manual driving or the like, the movable support body is fixed to the back support position and the seatback is maintained in a backrest use state in which the back of a person sitting on the seat can be supported, and in the second driving mode in which the degree of automatic driving is the predetermined reference or more, the movable support body can be displaced from the back support position to the retracted position to create the occupant moving space and changing the seating position of the occupant can be easily performed.

(7) In the aspect of above mentioned (6), the seat apparatus may further include an unlocking operator that performs a fixing releasing operation of the support body locking mechanism, wherein the unlocking operator is disposed at a position at which the unlocking operator is operable from a sitting space at rear side of the seat apparatus.

According to the configuration of above mentioned (7), a seat operation for changing the seating position can be performed by a person sitting at rear side of the seat apparatus.

(8) In the aspect of above mentioned (7), the unlocking operator may be disposed at a position at which the unlocking operator is operable from a sitting space of the seat apparatus.

According to the configuration of above mentioned (8), a seat operation for changing the seating position can also be performed by a person sitting on the seat apparatus.

According to the aspect of the present invention, it is possible to provide a seat apparatus for a vehicle in which an occupant moving space is able to be secured by moving a seatback while an influence on a sitting space is minimized.

### BRIEF DESCRIPTION OF THE DRAWINGS

FIG. 1 is a configuration view of a vehicle system of an embodiment.

FIG. 2 is a view showing an aspect in which a relative position and an attitude of a vehicle with respect to a traveling lane are recognized by an own vehicle position recognition part.

FIG. 3 is a view showing an aspect in which a target trajectory is generated on the basis of a recommended lane.

FIG. 4A is a plan view showing a seat layout of the vehicle of the embodiment.

FIG. 4B is a plan view showing a seat layout of the vehicle of the embodiment.

FIG. 5 is a perspective view of a seat apparatus of the embodiment.

FIG. 6A is a cross-sectional view taken along line VI-VI in FIG. 5.

FIG. 6B is a cross-sectional view showing an example where the seat apparatus in FIG. 6A is displaced.

FIG. 7A is a cross-sectional view showing a variant of the seat apparatus.

FIG. 7B is a cross-sectional view showing an example where the seat apparatus in FIG. 7A is displaced.

FIG. 8 is a flowchart showing main parts of control of the seat apparatus by a seat controller.

### DESCRIPTION OF EMBODIMENTS

Hereinafter, an embodiment of a vehicle control system, a vehicle control method, and a vehicle control program of the present invention will be described with reference to the accompanying drawings. In the embodiment, a vehicle control system is applied to an automatic driving vehicle. Here, there are levels in automatic driving. The level of automatic driving may be determined, for example, on a scale of whether the level is less than a predetermined reference or the predetermined reference or more. A case in which the level of automatic driving is less than a predetermined reference is, for example, a case in which manual driving is performed or a case in which only a drive assistance apparatus such as an adaptive cruise control system (ACC), a lane keeping assistance system (LKAS), or the like, is operated. A driving mode in which the level of automatic driving is less than a predetermined reference is an example of “a first driving mode.” In addition, a case in which the level of automatic driving is a predetermined reference or more is, for example, a case in which a drive assistance apparatus such as automatic lane changing (ALC), low speed car passing (LSP) or the like, having a higher control level than that of ACC or LKAS is operated, or a case in which automatic driving is automatically performed for lane changing, merging or branching. A driving mode in which the level of automatic driving is a predetermined reference or more is an example of “a second driving mode.” The predetermined reference may be arbitrarily set. In the embodiment, the first driving mode is manual driving, and the second driving mode is automatic driving.

### [Entire Configuration]

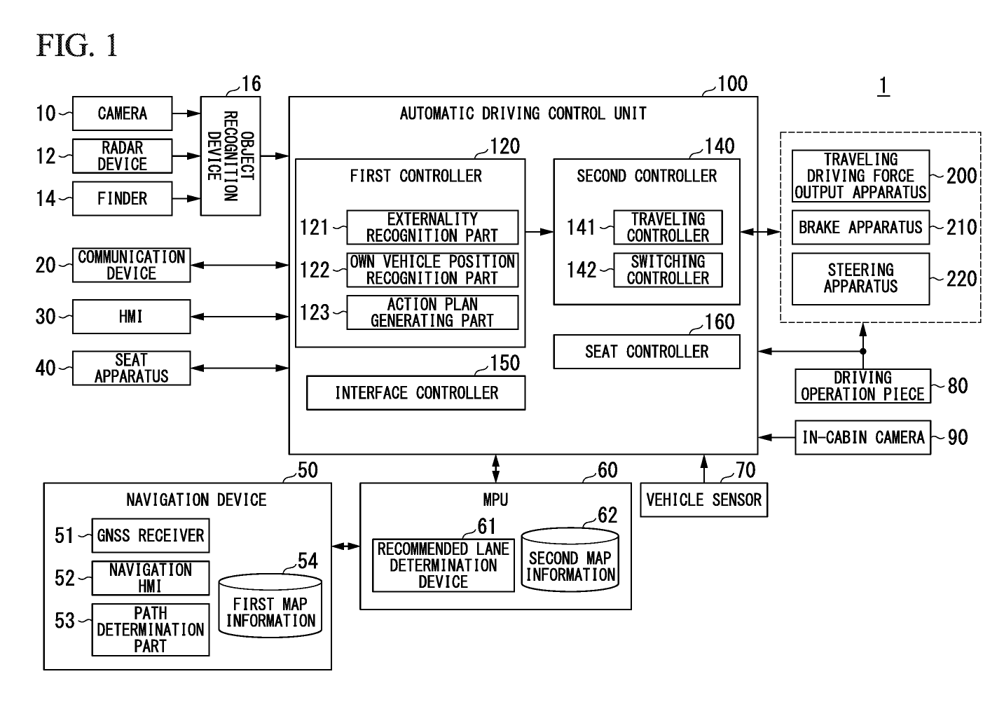

FIG. 1 is a configuration view of a vehicle system 1 of an embodiment. A vehicle on which the vehicle system 1 is mounted (hereinafter, referred to as a vehicle M) is, for example, a two-wheeled, three-wheeled, four-wheeled vehicle, or the like. A driving source thereof is an internal combustion engine such as a diesel engine, a gasoline engine, or the like, an electric motor, or a combination thereof. The electric motor is operated using an output generated by a generator connected to the internal combustion engine, or a discharge power of a secondary battery or a fuel cell.

The vehicle system 1 includes, for example, a camera 10, a radar device 12, a finder 14, an object recognition device 16, a communication device 20, a human machine interface (HMI) 30, a seat apparatus 40, a navigation device 50, a micro-processing unit (MPU) 60, a vehicle sensor 70, a driving operator 80, an in-cabin camera 90, an automatic driving control unit 100, a traveling driving force output apparatus 200, a brake apparatus 210 and a steering apparatus 220. These devices or instruments are connected to each other by a multiplex communication line such as a controller area network (CAN) communication line or the like, a serial communication line, a wireless communication network, or the like. Further, the configuration shown in FIG. 1 is merely an example, and a part of the configuration may be omitted or other configurational components may be added thereto.

“A vehicle control system” in a first embodiment includes, for example, the seat apparatus 40 and the automatic driving control unit 100.

The camera 10 is a digital camera using a solid-state image sensing device such as a charge coupled device (CCD), a complementary metal oxide semiconductor (CMOS), or the like. One or a plurality of cameras 10 are attached to arbitrary places on the vehicle M on which the vehicle system 1 is mounted. For imaging the front side, the camera 10 is attached to an upper section of a front windshield, a back surface of a rearview mirror, or the like. For imaging the rear side, the camera 10 is attached to an upper section of a rear windshield, a back door, or the like. For imaging the lateral sides, the camera 10 is attached to a door mirror or the like. The camera 10, for example, periodically repeats imaging of the surroundings of the vehicle M. The camera 10 may be a stereo camera.

The radar device 12 radiates radio waves such as millimeter waves to the surroundings of the vehicle M and detects the radio waves reflected by an object (reflected waves) to detect at least a position (a distance and an azimuth) of the object. One or a plurality of radar devices 12 are attached to arbitrary places on the vehicle M. The radar device 12 may detect a position and a speed of an object by using a frequency modulated continuous wave (FMCW) method.

The finder 14 is light detection and ranging or laser imaging detection and ranging (LIDAR) for measuring scattered light with respect to radiated light and detecting a distance to an object. One or a plurality of finders 14 are attached to arbitrary places on the vehicle M.

The object recognition device 16 performs sensor fusion processing with respect to the detection results using some or all of the camera 10, the radar device 12 and the finder 14, and recognizes a position, a type, a speed, and so on, of an object. The object recognition device 16 outputs the recognition results to the automatic driving control unit 100.

The communication device 20 communicates with another vehicle that is present around the vehicle M or communicates with various types of server device via a radio base station using, for example, a cellular network, a Wi-Fi network, Bluetooth (registered trade mark), dedicated short range communication (DSRC), or the like. In addition, the communication device 20 communicates with a terminal device carried by a person outside the vehicle.

The HMI 30 presents various types of information to an occupant in the vehicle and receives an input operation from the occupant. The HMI 30 may be, for example, various types of display device, a speaker, a buzzer, a touch panel, various types of operating switch, a key, or the like.

The seat apparatus 40 is a seat on which an occupant of the vehicle M sits, and a seat that can be electrically driven. The seat apparatus 40 includes a driver's seat on which a driver sits to manually drive the vehicle M using the driving operator 80, a passenger seat next to the driver's seat, a rear seat behind the driver's seat or the passenger seat, and so on. In the following description, “the seat apparatus 40” is assumed as the driver's seat. The seat apparatus 40 is operated under control by a seat controller 160, which will be described below. A specific configuration of the seat apparatus 40 will be described below.

The navigation device 50 includes, for example, a global navigation satellite system (GNSS) receiver 51, a navigation HMI 52 and a path determination part 53, and stores first map information 54 in a storage device such as a hard disk drive (HDD), a flash memory, or the like. The GNSS receiver identifies a position of the vehicle M on the basis of a signal received from a GNSS satellite. The position of the vehicle M may be identified or complemented by using an inertial navigation system (INS) using the output of the vehicle sensor 70. The navigation HMI 52 includes a display device, a speaker, a touch panel, a key, and so on. The navigation HMI 52 may be partially or entirely the same as the above-mentioned HMI 30. The path determination part 53 determines, for example, a route from a position of the vehicle M identified by the GNSS receiver 51 (or an input arbitrary position) to a destination input by an occupant using the navigation HMI 52 (for example, including information related to transit points when the vehicle travels to a destination) with reference to the first map information 54. The first map information 54 is, for example, information that expresses a road shape using a link showing a road and nodes connected by the link. The first map information 54 may also include information such as a curvature of a road, a point of interest (POI), or the like. The route determined by the path determination part 53 is output to the MPU 60. In addition, the navigation device 50 may perform route guidance using the navigation HMI 52 on the basis of the route determined by the path determination part 53. Further, the navigation device 50 may be realized by a function of a terminal device such as a smartphone, a tablet terminal, or the like, carried by a user. In addition, the navigation device 50 may transmit a current position and a destination to a navigation server via the communication device 20 and acquire a route returned from the navigation server.

The MPU 60 functions as, for example, a recommended lane determination device 61, and stores second map information 62 in a storage device such as a HDD, a flash memory, or the like. The recommended lane determination device 61 divides the route provided from the navigation device 50 into a plurality of blocks (for example, divides the route in every 100 [m] in a direction of travel of the vehicle), and determines a recommended lane for each block with reference to the second map information 62. The recommended lane determination device 61 determines the number of the lane from the left on which the vehicle travels. The recommended lane determination device 61 determines a recommended lane such that the vehicle M can travel on a reasonable traveling route to go to a branching destination when branching points, merging points, or the like, are present on the route.

The second map information 62 is map information that is more accurate than the first map information 54. The second map information 62 includes, for example, information of a center of the lane, information of a boundary of the lane, or the like. In addition, the second map information 62 may include road information, traffic regulations information, address information (address/zip code), facilities information, telephone number information, and so on. The road information includes information that indicating types of road such as an expressway, a toll road, a national road and a prefectural road, or information such as a lane number of the road, a region of an emergency parking area, a width of each lane, a slope of the road, a position (three-dimensional coordinates including a longitude, a latitude and a height) of the road, a curvature of a curve of the lane, positions of merging and branching points of lanes, signs installed on the road, and so on. The second map information 62 may be updated at any time through access to another apparatus using the communication device 20.

The vehicle sensor 70 includes a vehicle speed sensor configured to detect a speed of the vehicle M, an acceleration sensor configured to detect an acceleration, a yaw rate sensor configured to detect an angular speed around a vertical axis, an azimuth sensor configured to detect a direction of the vehicle M, and so on.

The driving operator 80 includes, for example, an acceleration pedal, a brake pedal, a shift lever, a steering wheel, and other operators. A sensor configured to detect an operation quantity or existence of an operation is attached to the driving operator 80, and the detection results thereof are output to the automatic driving control unit 100, the traveling driving force output apparatus 200, or one or both of the brake apparatus 210 and the steering apparatus 220.

The in-cabin camera 90 images, for example, an upper half of an occupant sitting on the seat apparatus 40 while having the face of the occupant around the center. The in-cabin camera 90, for example, periodically repeats imaging of the occupant. An image captured by the in-cabin camera 90 is output to the automatic driving control unit 100.

### [Automatic Driving Control Unit]

The automatic driving control unit 100 includes, for example, a first controller 120, a second controller 140, an interface controller 150 and the seat controller 160. The first controller 120, the second controller 140, the interface controller 150 and the seat controller 160 are realized by a processor such as a central processing unit (CPU) or the like executing a program (software). In addition, some or all of functional units from the first controller 120, the second controller 140, the interface controller 150 and the seat controller 160, which will be described below, may be realized by hardware such as a large scale integration (LSI), an application specific integrated circuit (ASIC), a field-programmable gate array (FPGA), or the like, or may be realized by cooperation between software and hardware.

The first controller 120 includes, for example, an outside recognition part 121, an own vehicle position recognition part 122, and an action plan generating part 123.

The outside recognition part 121 recognizes a position and a vehicle speed of a neighboring vehicle, and a state such as an acceleration thereof, or the like, on the basis of information input from the camera 10, the radar device 12 and the finder 14 via the object recognition device 16. The position of a neighboring vehicle may be represented by a representative point such as a centroid, corners, or the like, of the neighboring vehicle, or may be represented by a region indicated by an outline of the neighboring vehicle. “The state” of a neighboring vehicle may include an acceleration or a jerk of a neighboring vehicle, or “an action state” (for example, whether or not lane changing is being performed, or about to be performed).

In addition, the outside recognition part 121 may recognize positions of a guard rail, an electric pole, a parked vehicle, a person such as a pedestrian or the like, and other objects, in addition to a neighboring vehicle.

The own vehicle position recognition part 122 recognizes, for example, a lane through on the vehicle M is traveling (a traveling lane), and a relative position and an attitude of the vehicle M with respect to the traveling lane. The own vehicle position recognition part 122 recognizes a traveling lane by, for example, comparing a pattern of road lane markings obtained from the second map information 62 (for example, arrangement of solid lines and broken lines) with a pattern of a road lane markings around the vehicle M recognized from an image captured by the camera 10. In this recognition, a position of the vehicle M acquired from the navigation device 50 or results of a process using an INS may be added.

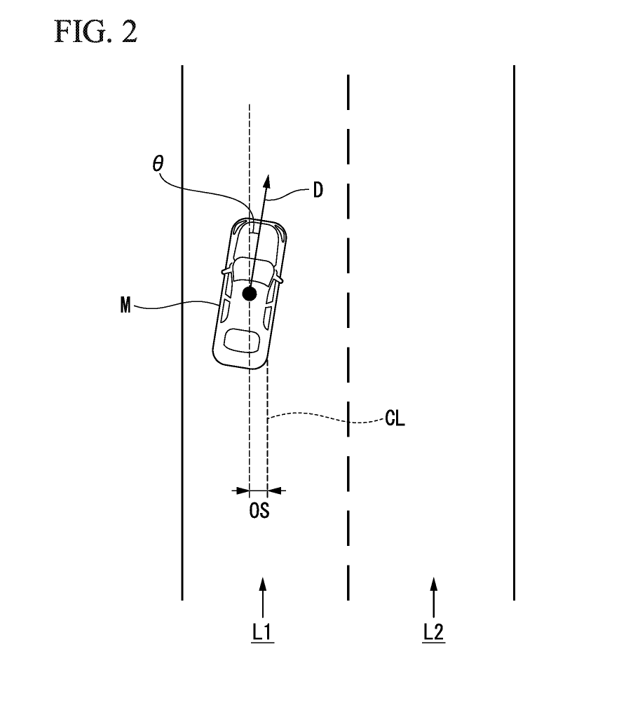

Then, the own vehicle position recognition part 122 recognizes, for example, a position or an attitude of the vehicle M with respect to a traveling lane. FIG. 2 is a view showing an aspect in which a relative position and an attitude of the vehicle M with respect to a traveling lane L1 are recognized by the own vehicle position recognition part 122. The own vehicle position recognition part 122 recognizes, for example, a divergence OS of a reference point (for example, a center of gravity) of the vehicle M from a traveling lane center CL, and an angle θ between a traveling direction D of the vehicle M and a line continuing from the traveling lane center CL, as a relative position and an attitude of the vehicle M with respect to the traveling lane L1. Further, instead of this, the own vehicle position recognition part 122 may recognize a position of a reference point of the vehicle M or the like with respect to any one of side end portions of the traveling lane L1 as a relative position of the vehicle M with respect to the traveling lane. The relative position of the vehicle M recognized by the own vehicle position recognition part 122 is provided to the recommended lane determination device 61 and the action plan generating part 123.

The action plan generating part 123 generates an action plan causing the vehicle M to perform automatic driving with respect to the destination or the like. For example, the action plan generating part 123 may determine events that are sequentially executed in the automatic driving control such that the vehicle M travels in the recommended lane determined by the recommended lane determination device 61 and deals with circumstances around the vehicle M. Events in the automatic driving of the embodiment include, for example, a constant speed traveling event in which the vehicle M travels in the same traveling lane at a constant speed, a lane changing event of changing a traveling lane of the vehicle M, an overtaking event in which the vehicle M overtakes a preceding vehicle, a following traveling event in which the vehicle M travels by following a preceding vehicle, a merging event of causing a vehicle to merge at a merging point, a branching event in which the vehicle M travels in a desired direction at a branching point of a road, an emergency stop event of causing the vehicle M to make an emergency stop, a switching event of terminating automatic driving and switching automatic driving to manual driving, and so on. In addition, an action for avoidance may be planned on the basis of surrounding circumstances of the vehicle M (existence of neighboring vehicles or pedestrians, lane narrowing or the like due to road construction) during execution of these events.

The action plan generating part 123 generates a target trajectory on which the vehicle M will travel. The target trajectory includes, for example, a speed element. For example, a plurality of future reference times may be set at each of predetermined sampling times (for example, every several tenths of a [sec]), and the target trajectory may be generated as a set of target points (trajectory points) reached at these reference times. For this reason, this indicates that, when an interval between trajectory points is large, the vehicle M is traveling on a section between trajectory points at a high speed.

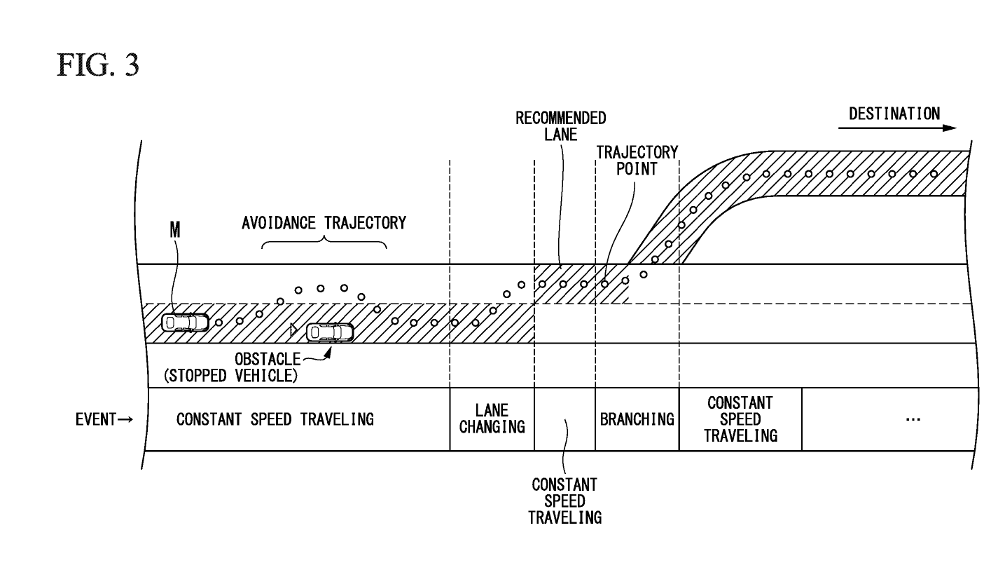

FIG. 3 is a view showing an aspect in which a target trajectory is generated on the basis of the recommended lane. As shown in FIG. 3, the recommended lane is set so that it is convenient for traveling to the destination along the route.

The action plan generating part 123 starts a lane changing event, a branching event, or a merging event and the like when the vehicle M reaches a predetermined distance before a recommended lane switching point (may be determined according to the type of event). When there is a need to avoid an obstacle during execution of one of these events, an avoidance trajectory is generated as shown in the drawing.

The action plan generating part 123 generates, for example, candidates for a plurality of target trajectories, and selects an optimal target trajectory appropriate for a route to a destination at that point of time from a viewpoint of safety and efficiency.

The second controller 140 includes, for example, a traveling controller 141 and a switching controller 142. The traveling controller 141 controls the traveling driving force output apparatus 200, the brake apparatus 210 and the steering apparatus 220 such that the vehicle M passes along the target trajectory generated by the action plan generating part 123 at scheduled times.

The switching controller 142 switches a driving mode of the vehicle M on the basis of the action plan generated by the action plan generating part 123. For example, the switching controller 142 may switch the driving mode from manual driving to automatic driving at an expected starting point of automatic driving. In addition, the switching controller 142 may switch the driving mode from automatic driving to manual driving at an expected termination point of automatic driving.

In addition, the switching controller 142 may switch between automatic driving and manual driving, for example, on the basis of a switching signal input from an automatic driving changeover switch included in the HMI 30. In addition, the switching controller 142 may switch the driving mode of the vehicle M from automatic driving to manual driving on the basis of an operation that instructs acceleration, deceleration or steering with respect to the driving operator 80 such as an accelerator pedal, a brake pedal, a steering wheel, or the like.

During manual driving, the input information from the driving operator 80 is directly output to the traveling driving force output apparatus 200, the brake apparatus 210 and the steering apparatus 220. In addition, the input information from the driving operator 80 may be output to the traveling driving force output apparatus 200, the brake apparatus 210 and the steering apparatus 220 via the automatic driving control unit 100. Electronic control units (ECUs) of the traveling driving force output apparatus 200, the brake apparatus 210 and the steering apparatus 220 perform operations thereof on the basis of the input information from the driving operator 80 or the like.

The interface controller 150 outputs a notification and the like regarding a traveling state during automatic driving or manual driving of the vehicle M, a timing when automatic driving and manual driving are switched between, a request or the like for causing an occupant to perform manual driving, and so on, to the HMI 30. In addition, the interface controller 150 may output information on control contents regarding the seat controller 160 to the HMI 30. In addition, the interface controller 150 may output the information received by the HMI 30 to the first controller 120 or the seat controller 160.

The seat controller 160 controls, for example, the seat apparatus 40 on the basis of the information received by the HMI 30, and further controls the seat apparatus 40 as described below when the driving mode is switched by the switching controller 142.

The traveling driving force output apparatus 200 outputs a traveling driving force (torque) for causing the vehicle to travel to the driving wheels. The traveling driving force output apparatus 200 includes, for example, a combination of an internal combustion engine, an electric motor, a transmission device, and so on, and an ECU configured to control them. The ECU controls the above-mentioned components according to the information input from the traveling controller 141 or information input from the driving operator 80.

The brake apparatus 210 includes, for example, a brake caliper, a cylinder configured to transmit a hydraulic pressure to the brake caliper, an electric motor configured to generate a hydraulic pressure in the cylinder, and a brake ECU. The brake ECU is configured to control the electric motor according to the information input from the traveling controller 141 or the information input from the driving operator 80, and to output a brake torque to the wheels according to a brake operation. The brake apparatus 210 may include a mechanism configured to transmit a hydraulic pressure generated by an operation of the brake pedal included in the driving operator 80 to the cylinder via a master cylinder as a back-up. Further, the brake apparatus 210 is not limited to the above-mentioned configurations, and may be an electronic control type hydraulic brake apparatus configured to control an actuator according to information input from the traveling controller 141 or information input from the driving operator 80 and transmit a hydraulic pressure of the master cylinder to the cylinder. In addition, the brake apparatus 210 may include a plurality of brake device systems in consideration of safety.

The steering apparatus 220 includes, for example, a steering ECU and an electric motor.

The electric motor applies, for example, a force to a rack and pinion mechanism and changes a direction of the steered wheels. The steering ECU drives the electric motor and changes the direction of the steered wheels according to the information input from the traveling controller 141 and the information input from the driving operator 80.

### [Configuration and Control of Seat Apparatus 40]

Hereinafter, a configuration of the seat apparatus 40 of the embodiment and control of the seat apparatus 40 by the seat controller 160 will be described.

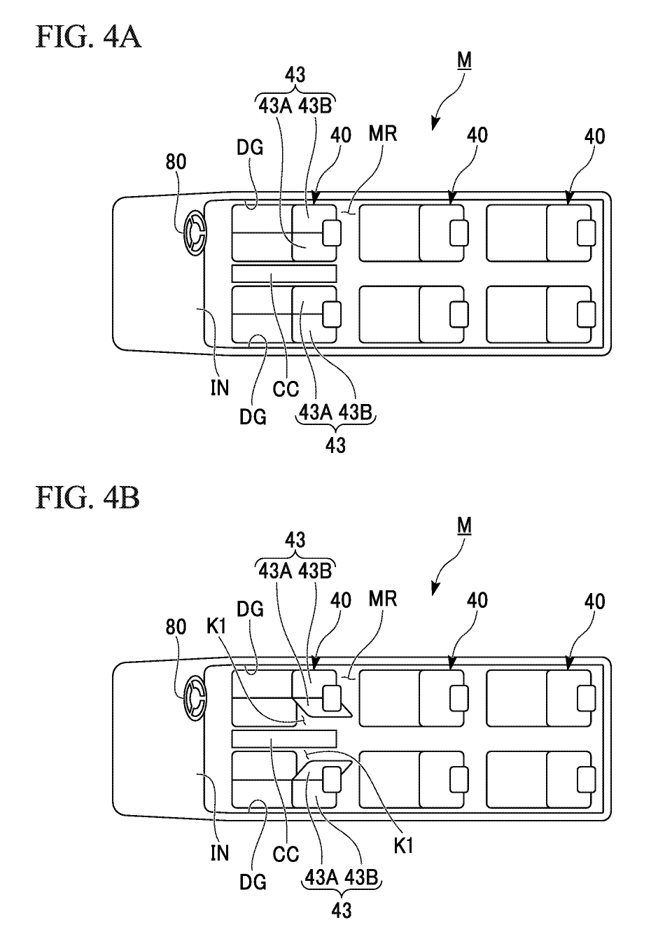

As shown in FIGS. 4A and 4B, the vehicle M includes a plurality of front and rear rows of seat apparatuses 40 (in an example in the drawings, three rows) in a passenger compartment MR. One of the seat apparatuses 40 of the foremost row is a driver's seat on which a driver sits to manually drive the vehicle M using the driving operator 80, and is in a forwardly facing state (see FIG. 4A) in which the seat apparatus 40 is directed toward a front side of the vehicle during manual driving traveling. Meanwhile, in the seat apparatus 40 that is a driver's seat, a seatback 43 becomes pivotable during automatic driving traveling and it is possible to make the occupant's access to the driver's seat easier (see FIG. 4B). Further, like the driver's seat, in the seat apparatus 40 of a passenger seat, the seatback 43 is also pivotable. In addition, the vehicle is not limited to a vehicle having three rows of seats. Reference symbol IN in the drawings designates an installment panel, reference symbol CC designates a center console, and reference symbol DG designates a door garnish.

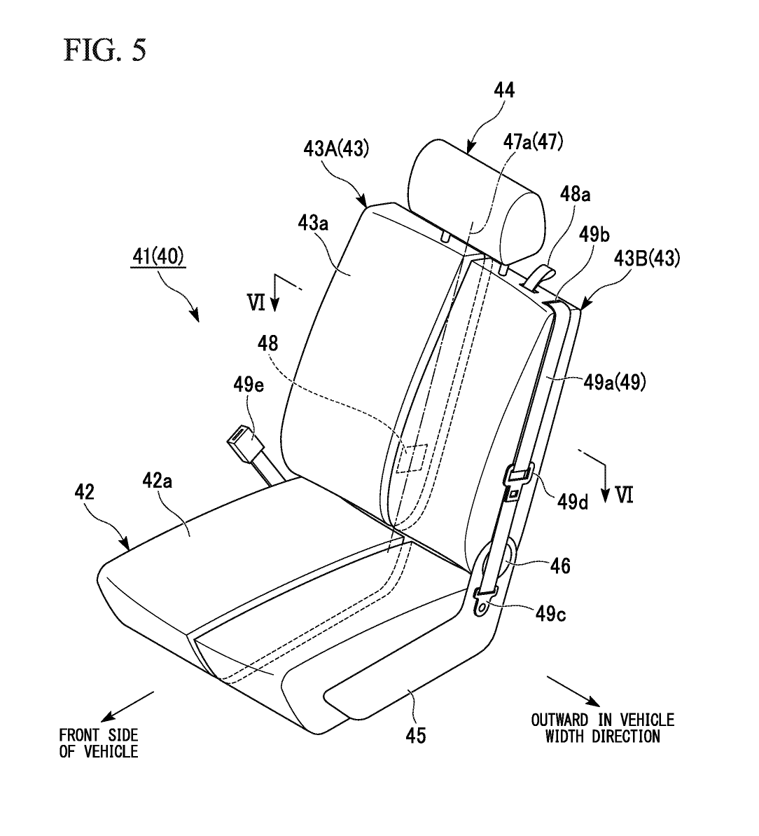

As shown in FIG. 5, the seat apparatus 40 of the embodiment includes the base frame 45 mounted on a floor of the vehicle body via a slide rail or the like, and the seat main body 41 mounted on the base frame 45.

The seat main body 41 includes the seat cushion 42, the seatback 43 and the head rest 44.

The seat cushion 42 is supported on the base frame 45, and supports the buttocks of an occupant sitting on the seat using the seating surface 42s from below.

The seatback 43 is supported on the rear section of the base frame 45, stands up above the rear section of the seat cushion 42, and supports the back of the occupant sitting on the seat using the backrest surface 43s from behind.

The head rest 44 is supported by an upper side of the seatback 43 and supports the head of the occupant sitting on the seat from behind.

Both sides of a lower end portion of the seatback 43 in a standing state are supported by left and right rear sections of the base frame 45 via the reclining mechanism 46.

The seatback 43 of the embodiment is a left-and-right split structure using a central section in the seat width direction as a boundary. The seatback 43 includes a first support body 43A formed on an inner side of the seatback 43 in the vehicle width direction and a second support body 43B formed on an outer side of the seatback 43 in the vehicle width direction, which are separate left and right bodies. Further, in the drawing, while the seat cushion 42 is also a left-and-right split structure, the seat cushion 42 may be a laterally integrated body.

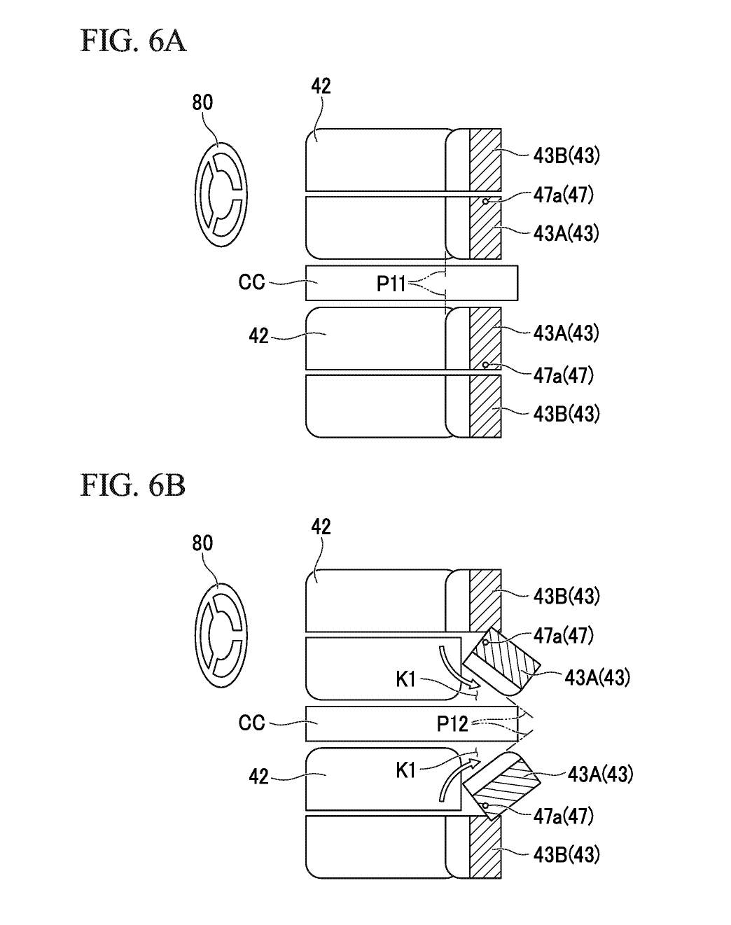

As shown in FIG. 6A and FIG. 6B, the first support body 43A that forms an inner side of the seatback 43 in the vehicle width direction is a movable support body that is displaceable from a back support position P11 (see FIG. 6A) that supports the back of a person sitting on the seat to a retracted position P12 (see FIG. 6B). Hereinafter, the first support body 43A is referred to as a movable support body 43A. The movable support body 43A is reclinable, and the back support position P11 and the retracted position P12 vary according to a reclining angle. When the movable support body 43A is disposed at the back support position P11, the seatback 43 is in a state in which the back of a person sitting on the seat can be supported by the entire seatback 43 (hereinafter, referred to as a backrest use state).

The second support body 43B that forms an outer side of the seatback 43 in the vehicle width direction serves as a fixed support body configured to support the back of a person sitting on the seat and fixed at a back support position (a position shown in FIGS. 6A and 6B). Hereinafter, the second support body 43B is referred to as a fixed support body 43B. The fixed support body 43B does not move from the back support position like the first support body 43A but is reclinable.

The seatback 43 includes a moving mechanism 47 configured to move the movable support body 43A from the back support position P11, at which the back of a person sitting on the seat is supported, to the retracted position P12. When the movable support body 43A is displaced to the retracted position P12, an inner side position in the vehicle width direction where the movable support body 43A of the seatback 43 was placed is made to an open space K1 that is open when seen in a front view of the seatback 43a such as the movable support body 43A was cutout.

The moving mechanism 47 includes a pivot shaft 47a extending in an upward/downward direction at the inner side of the seatback 43 in the seat width direction. The movable support body 43A is pivoted rearward about the pivot shaft 47a (in other words, is pivoted to move the outer side of the movable support body 43A in the seat width direction rearward), and is displaced from the back support position P11 to the retracted position P12.

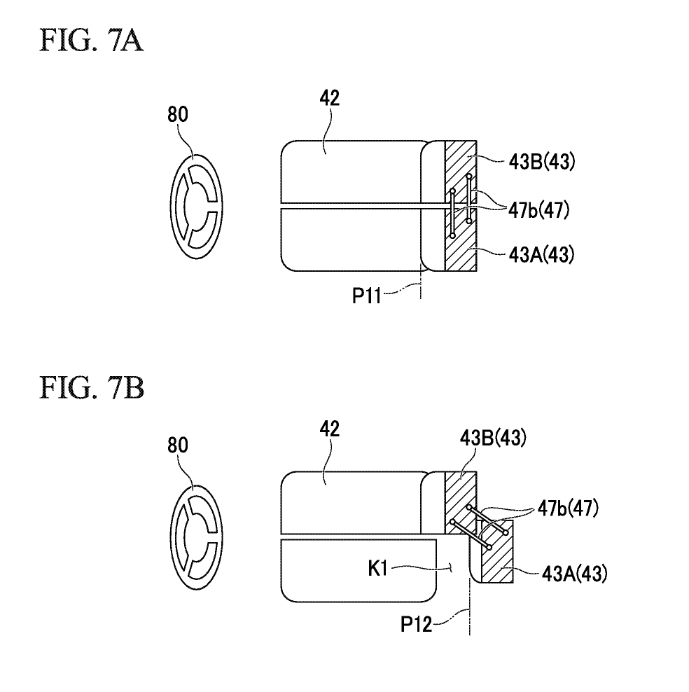

Further, the moving mechanism 47 is not limited to a configuration in which the movable support body 43A is pivoted as long as the movable support body 43A is displaceable from the back support position P11 to the retracted position P12. For example, as shown in FIGS. 7A and 7B, a configuration in which the movable support body 43A and the fixed support body 43B are connected by a link member 47b for moving the movable support body 43A along an arbitrary movement trajectory may be provided. In addition, a configuration in which the movable support body 43A is simply detachable may also be provided.

Returning to FIG. 5, the seatback 43 includes a back frame (not shown) reclinably connected to the base frame 45. The back frame fixedly supports the fixed support body 43B and pivotably supports the movable support body 43A.

When the seatback 43 is in a backrest use state, pivoting movement of the movable support body 43A is restricted by a support body locking mechanism 48. The support body locking mechanism 48 switches between a support body moving locked state in which movement of the movable support body 43A from the back support position P11 is restricted and a support body moving unlocked state in which the restriction is released. The support body locking mechanism 48 maintains a support body moving locked state during manual driving traveling and is brought into a support body moving unlocked state according to an unlocking operation during automatic driving traveling. The seat controller 160 can detect that the movable support body 43A is disposed at the back support position P11 (the seatback 43 is in the backrest use state) from the state of the support body locking mechanism 48.

Referring to FIGS. 6A and 6B, when the movable support body 43A is pivoted from the back support position P11 to the retracted position P12, the open space K1 is created at a position at which the movable support body 43A was placed, and it becomes possible for an occupant to move through the open space K1 in order to change seating position. Since the open space K1 is created inside the seatback 43 in the vehicle width direction, it is also consistent with a configuration in which an occupant passes through the passenger compartment in the vehicle width direction in a walk-through way. Even when an occupant is sitting on the seat, the open space K1 can be used if the person sitting on the seat moves to the side of the fixed support body 43B. Since the movable support body 43A is pivoted rearward from the back support position P11, an influence on a sitting space of the seat is also reduced.

As shown in FIG. 5, the vehicle M includes a three-point type seat belt apparatus 49. The seat belt apparatus 49 includes a retractor (not shown) disposed inside of the seatback 43 and outer sides of the seatback 43 in the vehicle width direction and configured to wind the webbing 49a that restricts a person sitting on the seat (in the embodiment, inside the fixed support body 43B). The webbing 49a unrolled from the retractor is pulled upward from the through-hole 49b of the upper end of the seatback 43. The webbing 49a pulled out of the through-hole 49b is folded downward at an outside of the seatback 43 in the vehicle width direction, and extends downward along an outer surface of the seatback 43. A tip portion of the webbing 49a is fixed to an outer side of the base frame 45 in the vehicle width direction via the outer anchor 49c. The tongue plate 49d through which the webbing 49a is inserted is disposed between the through-hole 49b and the outer anchor 49c. The tongue plate 49d is attached and detached to/from the buckle 49e supported inside the base frame 45 in the vehicle width direction.

In this way, the seat belt apparatus 49 realized on the seat apparatus 40 can be efficiently configured by supporting the seat belt apparatus 49 using the fixed support body 43B of the seatback 43. Further, a configuration in which the retractor is not provided in the seatback 43, and the retractor is supported by the base frame 45, the vehicle body floor, or the like, and the fixed support body 43B has a function as a guide configured to guide the webbing 49a pulled out of the retractor to the upper end of the seatback 43, may be used.

The seat apparatus 40 includes an operation strap 48a serving as an unlocking operator configured to cause the support body locking mechanism 48 to be brought into a support body moving unlocked state and protruding from the outer upper end of the seatback 43 in the vehicle width direction (the fixed support body 43B). The operation strap 48a switches the support body locking mechanism 48 to the support body moving unlocked state when the operation strap 48a is operated by being pulled out of the seatback 43 against the biasing force. Accordingly, the movable support body 43A becomes pivotable. The operation of pulling the operation strap 48a against the biasing force becomes an unlocking operation of the support body locking mechanism 48. That is, the unlocking operation with the operation strap 48a is ineffective (stopped or omitted) during manual driving traveling and effective during automatic driving traveling.

As the operation strap 48a protrudes from the upper end of the seatback 43, a person sitting on the seat apparatus 40 can operate the operation strap 48a, and a person sitting behind the seat apparatus 40 can also operate the operation strap 48a. For this reason, the unlocking operation for changing the seating position can be performed by an occupant sitting in front or behind, and convenience is improved. Further, the unlocking operator for the support body moving unlocked state is not limited to the operation strap 48a and, for example, may be a lever, a button, or the like.

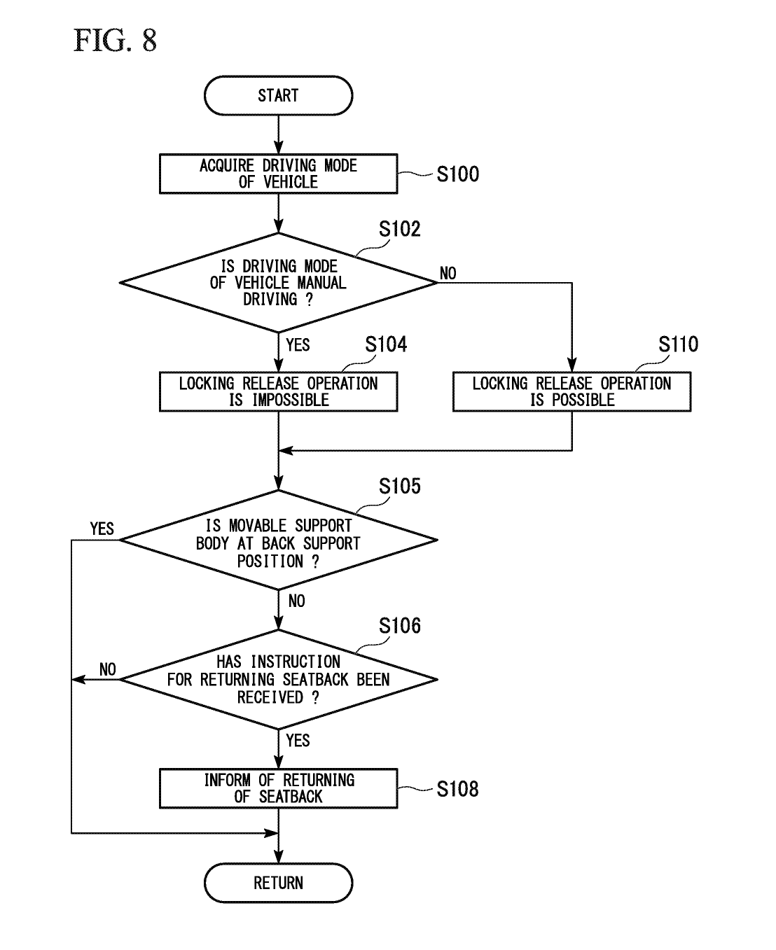

Hereinafter, main parts of the control of the seat apparatus 40 by the seat controller 160 will be described with reference to FIG. 8. A control flow shown in FIG. 8 is repeatedly performed at predetermined intervals when the power supply is turned ON (the main switch is turned ON).

First, the seat controller 160 acquires a driving mode of the vehicle M (step S100), and determines whether the driving mode of the vehicle M is manual driving (step S102).

In step S102, when it is determined that the driving mode of the vehicle M is manual driving (in step S102, YES), an unlocking operation of the support body locking mechanism 48 is made impossible (step S104). That is, the support body locking mechanism 48 is maintained in the support body moving locked state.

In step S102, when it is determined that the driving mode of the vehicle M is not manual driving (in step S102, NO), the driving mode of the vehicle M is automatic driving. In this case, an unlocking operation of the support body locking mechanism 48 becomes possible (step S110). That is, the support body locking mechanism 48 can be brought into the support body moving unlocked state according to the unlocking operation.

After step S104 and step S110, the seat controller 160 determines whether the movable support body 43A is disposed at the back support position P11 (step S105). When it is determined that the movable support body 43A is disposed at the back support position P11 (in step S105, YES), the processing is terminated temporarily. When it is determined that the movable support body 43A is not disposed at the back support position P11 (is disposed at the retracted position P12) (in step S105, NO), the processing proceeds to step S106.

In step S106, the seat controller 160 determines whether an instruction for returning the movable support body 43A to the back support position P11 (returning the seatback 43 to a backrest use state) has been received from the HMI 30 or the action plan generating part 123 (step S106). When an instruction for returning the movable support body 43A to the back support position P11 has not been received (in step S106, NO), the processing is terminated temporarily. When an instruction for returning the movable support body 43A to the back support position P11 has been received (in step S106, YES), the seat controller 160 outputs, for example, an instruction for informing an occupant of returning of the movable support body 43A to the back support position P11 (returning the seatback 43 to a backrest use state) (step S108), and processing of the flowchart is terminated.

According to the seat apparatus 40 of the above-mentioned embodiment, the seatback 43 is provided as the left-and-right split structure, one of the separate left and right bodies of the seatback 43 is provided as the movable support body 43A, and the seatback 43 is moved from the back support position P11, at which the back of a person sitting on the seat is supported, to the retracted position P12, and a position at which the movable support body 43A was positioned becomes the open space K1. It becomes possible for the occupant to come and go through the open space K1 formed in the seatback 43, and changing of a seating position becomes easy. That is, since one of the separate left and right bodies of the seatback 43 is moved to form the open space K1, compared to a case in which the entire seatback 43 is moved to form the open space K1, it is possible to secure the occupant moving space by moving the seatback 43 while an influence on the sitting space is minimized.

In addition, since the movable support body 43A that forms an inner side of the seatback 43 in the vehicle width direction is moved to create the open space K1, it is possible to secure the occupant moving space inside the passenger compartment in the vehicle width direction and to fit well with a walk-through configuration in which the inner side of the passenger compartment in the vehicle width direction is made as a pathway for the occupant.

In addition, since the movable support body 43A is pivoted about the pivot shaft 47a which is disposed at the inner side in the seat width direction and the open space K1 is created at the outer side in the seat width direction (inner side of the seatback 43 in the vehicle width direction), it is possible to easily secure the occupant moving space inside the passenger compartment in the vehicle width direction.

In addition, since the movable support body 43A is moved rearward from the back support position P11 to be displaced to the retracted position P12, the open space K1 can be easily created even when a person is sitting on the seat, and the occupant moving space can be easily secured.

In addition, as at least a portion of the seat belt apparatus 49 is held at the fixed support body 43B that forms the outer side of the seatback 43 in the vehicle width direction, the seat apparatus 40 including the seat belt apparatus 49 can be efficiently formed.

In addition, the seat apparatus 40 includes the support body locking mechanism 48 configured to fix the movable support body 43A at the back support position P11 and the seat controller configured to control the support body locking mechanism 48, and the seat controller fixes the movable support body 43A at the back support position P11 by using the support body locking mechanism 48 when the vehicle on which the seat apparatus 40 is mounted operates in a first driving mode in which a level of automatic driving is less than a predetermined reference, and enables a fixing releasing operation of the support body locking mechanism 48 when the vehicle operates in a second driving mode in which the level of automatic driving is the predetermined reference or more.

According to this configuration, in the first driving mode in which the level of automatic driving is less than the predetermined reference such as during manual driving, the movable support body 43A is fixed to the back support position P11 and the seatback 43 is maintained in a backrest use state in which the back of a person sitting on the seat can be supported, and in the second driving mode in which the level of automatic driving is the predetermined reference or more, the movable support body 43A can be displaced from the back support position P11 to the retracted position P12 in order to secure the occupant moving space and changing of the seating position can be easily performed.

In addition, the seat apparatus 40 includes the operation strap 48a configured to perform a fixing releasing operation of the support body locking mechanism 48, and the operation strap 48a is disposed at a position at which the operation strap 48a is operable from a sitting space of the seat apparatus 40 and a sitting space behind the seat apparatus 40.

Any one of a person sitting on the seat apparatus 40 and a person sitting behind the seat apparatus 40 can perform a seat operation for changing the seating position, and convenience can be improved.

Further, the present invention is not limited to the embodiment, and for example, the seatback may be a left-and-right split structure using a position deviated from a central section in the seat width direction as a boundary. The present invention is not limited to an application to an automatic driving vehicle and may be applied to all of seat apparatuses for a vehicle in which an occupant moving space is desired to be secured by moving a seatback.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A seat apparatus for a vehicle comprising:
a seatback that supports a back of a person sitting on the seat apparatus and that includes a first support body and a second support body, the first support body being one side of the seatback in a seatback width direction and the second support body being the other side of the seatback in the seatback width direction, one of the first support body and second support body being a movable support body; and
a moving mechanism that displaces the movable support body from a back support position to a retracted position, the back support position being a position where the movable support body is placed in order to support the back of the person sitting on the seat, the retracted position being a position where the movable support body is placed in order to create an open space where the movable support body was placed.

2. The seat apparatus for a vehicle according to claim 1,
wherein the movable support body forms an inner side of the seatback in the seatback width direction.

3. The seat apparatus for a vehicle according to claim 1,
wherein the moving mechanism comprises a pivot shaft vertically extending at an inner side of the seatback in the seatback width direction, and
the moving mechanism displaces the movable support body from the back support position to the retracted position by pivoting the movable support body about the pivot shaft.

4. The seat apparatus for a vehicle according to claim 1,
wherein the moving mechanism displaces the movable support body from the back support position to the retracted position by moving the movable support body rearward.

5. The seat apparatus for a vehicle according to claim 1,
wherein the other one of the first support body and the second support body is set as a fixed support body, and
the fixed support body forms an outer side of the seatback in the seatback width direction and at least a portion of a seat belt apparatus is held at the fixed support body.

6. The seat apparatus for a vehicle according to claim 1, further comprising:
a support body locking mechanism that fixes the movable support body at the back support position; and
a seat controller that controls the support body locking mechanism,
wherein the seat controller fixes the movable support body at the back support position by using the support body locking mechanism when a vehicle on which the seat apparatus is mounted operates in a first driving mode in which a level of automatic driving is less than a predetermined reference, and enables a fixing releasing operation of the support body locking mechanism when the vehicle operates in a second driving mode in which the level of the automatic driving is the predetermined level or more.

7. The seat apparatus for a vehicle according to claim 6, further comprising:
an unlocking operator that performs a fixing releasing operation of the support body locking mechanism,
wherein the unlocking operator is disposed at a position at which the unlocking operator is operable from a sitting space at a rear side of the seat apparatus.

8. The seat apparatus for a vehicle according to claim 7,
wherein the unlocking operator is disposed at a position at which the unlocking operator is operable from a sitting space of the seat apparatus.
